(19) United States
(12) Patent Application Publication
(10) Pub. No.: US 2024/0045208 A1
(43) Pub. Date: Feb. 8, 2024

(54) VIRTUAL REALITY DISPLAY ADAPTERS

(71) Applicant: The Trustees of Princeton University, Princeton, NJ (US)

(72) Inventors: Isla Xi Han, Princeton, NJ (US); Sophie Mengzhu Jiang, Princeton, NJ (US); Genyuan Hu, Princeton, NJ (US); Priscilla Zhang, Princeton, NJ (US)

(73) Assignee: The Trustees of Princeton University, Princeton, NJ (US)

(21) Appl. No.: 18/228,068

(22) Filed: Jul. 31, 2023

Related U.S. Application Data
(60) Provisional application No. 63/394,337, filed on Aug. 2, 2022.

(51) Int. Cl. G02B 27/01; G06T 17/00

(52) U.S. Cl. CPC G02B 27/0172; G06T 17/00

(57) ABSTRACT

Devices and systems are disclosed that utilize single-eye virtual reality adapters. The single-eye virtual reality adapter may include a body and a VR lens. The body may be configured to be disposed around a display screen. The body may have an inner surface and an outer surface, separated by a first sidewall and a second sidewall. The body may define a lens opening extending from the outer surface to the inner surface. The body may define a display opening extending from the first sidewall to the second sidewall (e.g., to slidably receive a display screen through the display opening). The VR lens may be removably coupled to the body. The VR lens may be disposed within the lens opening. The VR lens configured to prevent the lens from contacting the display screen; for example, the VR lens may be positioned at a distance d1>0 in front of the display screen.

### CROSS-REFERENCE TO RELATED APPLICATIONS

The present application claims priority to 63/394,337, filed Aug. 2, 2022, the contents of which are incorporated by reference herein in its entirety.

### TECHNICAL FIELD

The present application is drawn to the field of virtual reality (VR), and specifically, to adapters that are removably attachable to a display that can create a VR experience for a user.

### BACKGROUND

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

Immersive experiences have an increasing importance in enriching people's lives, and the rapid expansion of the immersive technologies leads to increasing demand for highly compatible hardware.

From 3D movies to the metaverse, immersive technology enables new dimensions of interaction with the community and the environment, but technical barriers, affordability of VR headsets, and convenience of use have prevented more users from experiencing the virtual world. Despite this, virtual reality devices are becoming increasingly compact and portable. However, smartphones, as one of the most widely-used standalone virtual reality devices, are restricted to provide users with interactions of higher complexity and immersivity.

In addition to the higher-priced fully immersive VR headsets, the public is still looking for more accessible and affordable options for mobile devices like smartphones and tablets. Currently on the market, such options are limited to bulky, heavy phone-insertable headsets that offer low portability, low malleability, and low compatibility across devices. The hand-held VR controller devices that are available on the market are not compact in size and need pairing with a specific brand of VR headset.

### BRIEF SUMMARY

Various deficiencies in the prior art are addressed below by the disclosed compositions of matter and techniques.

In various aspects, a single-eye virtual reality adapter may be provided. The single-eye virtual reality adapter may include a body and a VR lens.

The body may be configured to be disposed around a display screen. The body may have an inner surface and an outer surface. The inner and outer surfaces may be separated by sidewalls, such as a first sidewall and a second sidewall. The body may define a lens opening extending from the outer surface to the inner surface. The body may define a display opening extending from the first sidewall to the second sidewall.

The VR lens may be removably coupled to the body. The VR lens may be disposed within the lens opening. The VR lens may be configured to be kept at a distance from any display screen around which the body is disposed. In some embodiments, the VR lens may be positioned at a distance d1>0 in front of a portion of the display screen. In some embodiments, d1 may be equal to the effective focal length. In some embodiments, d1 may be less than the effective focal length.

The single-eye VR adapter may include a shield coupled to the outer surface. The shield may be at a fixed position on the body, opposite the lens opening. The shield may be disposed at a distance d2>0 from the outer surface of the body. The shield may have an inward-facing surface that faces the outer surface of the body. The shield may have an outward-facing surface that faces away from the body.

In some embodiments, the outer surface of the body may include one or more protrusions extending towards the inward-facing surface of the shield. In some embodiments, the inward-facing surface of the shield may include one or more protrusions extending towards the outer surface of the body. In some embodiments, both exist.

The inner surface of the body may define a set of sockets, each socket of a set opposing the other across the display opening. Each socket may define a recess configured to slidably receive the display screen. A compressible material may be disposed in each recess. The coefficient of friction of the compressible materials should be sufficient to prevent the display screen from sliding through the body without a user applying force. In some embodiments, each compressible material may have a coefficient of friction that is higher than a coefficient of friction of a material forming another portion of the body. In some embodiments, a width of each recess (i.e., a dimension in a direction parallel to a central axis of the lens opening) may be no more than 25 mm.

In some embodiments, the body may have a generally uniform thickness, the thickness being defined as a shortest distance between the first sidewall and the second sidewall at a given location. In some embodiments, a portion of the body defining the lens opening may have a first thickness that is greater than a thickness of the body at a second location.

In some embodiments, the maximum thickness of the body may be no more than 50 mm. In some embodiments, the maximum thickness of the body may be no more than 45 mm. In some embodiments, the maximum thickness of the body may be no more than 40 mm. In some embodiments, the maximum thickness of the body may be no more than 35 mm. In some embodiments, the maximum thickness of the body may be no more than 30 mm. In some embodiments, the maximum thickness of the body may be no more than 25 mm. In some embodiments, the maximum thickness of the body may be no more than 20 mm. In some embodiments, the maximum thickness of the body may be no more than 15 mm. In some embodiments, the maximum thickness of the body may be no more than 10 mm. In some embodiments, the maximum thickness is at least 1 mm. In some embodiments, the maximum thickness is at least 2 mm. In some embodiments, the maximum thickness is at least 3 mm. In some embodiments, the maximum thickness is at least 4 mm. In some embodiments, the thickness is at least 3 mm. In some embodiments, the maximum thickness is at least 5 mm.

In some embodiments, a maximum dimension 149 of the body, such as from a first point on an outer surface to another point on the outer surface opposite the first point, is at least 75 mm. In some embodiments, the maximum dimension is at least 100 mm. In some embodiments, the maximum dimension is at least 125 mm. In some embodiments, the maximum dimension is at least 150 mm. In some embodiments, the maximum dimension is no more than 150 mm. In some embodiments, the maximum dimension is no more than 200 mm. In some embodiments, the maximum dimension is no more than 300 mm. In some embodiments, the maximum dimension is no more than 400 mm. In some embodiments, the maximum dimension is no more than 500 mm.

The outer surface of the body may have various configurations. In some embodiments, a portion of the outer surface may have flat or convex cross-section.

In some embodiments, the single-eye VR adapter may free of any electronic component. In some embodiments, the single-eye VR adapter may include one or more electronic components. Non-limiting examples of electronic components that may be used include a battery, capacitor, sensor, a speaker, a microphone, a display screen, and/or a camera. Various I/O interfaces may be incorporated as well; in some embodiments, the VR adapter may include a wireless transmitter or transceiver (such as a Wi-Fi, bluetooth, or RFID transmitter or transceiver), a USB interface, etc.

The single-eye VR adapter may include other components that allow it to function as a wearable device. For example, in some embodiments, the single-eye VR adapter may include a watch.

In various aspects, a kit may be provided. The kit may include one or more VR adapter bodies, and one or more VR lenses. Each VR adapter body may be configured to be disposed around a display screen. Each VR adapter body may have an inner surface and an outer surface, separated by a first sidewall and a second sidewall. Each VR adapter body may define a lens opening extending from the outer surface to the inner surface. Each VR adapter body may define a display opening extending from the first sidewall to the second sidewall. The VR lenses may be configured to be disposed within a lens opening of at least one of the one or more VR lenses.

The kit may include a plurality of VR adapter bodies and a plurality of VR lenses. The plurality of VR lenses includes a lens for each VR adapter body in the kit, and one or more replacement lens. In some embodiments, at least a portion of first single-eye VR adapter in a first orientation is configured to be slidably received by the second single-eye VR adapter in a second orientation, such that the lens opening of the first single-eye VR adapter faces a first direction, and the lens opening of the second single-eye VR adapter faces a second direction different from the first direction.

In some embodiments, when the first single-eye VR adapter is coupled to the second single-eye VR adapter, a portion of a user's body (such as the user's finger, hand, wrist, arm, foot, or leg), can extend through the display opening on the first single-eye VR adapter and the display opening of the second single-eye VR adapter.

In some embodiments, the body of the first and second VR adapters may be shaped identically. In some embodiments, the body of the first and second VR adapters may be shaped differently. As disclosed herein, the body of the VR adapters may include a shield. In some embodiments, each shield is identical. In some embodiments, the shield of the first single-eye VR adapter is shaped differently from the shield of the second single-eye VR adapter.

In various aspects, a system may be provided. The system may include a display screen and a plurality of single-eye VR adapters (including a first single-eye VR adapter and a second single-eye VR adapter) as disclosed herein. The first single-eye VR adapter may be separated from the second single-eye VR adapter (i.e., separated by a distance d3>0)

### BRIEF DESCRIPTION OF DRAWINGS

The accompanying drawings, which are incorporated in and constitute a part of this specification, illustrate embodiments of the present invention and, together with a general description of the invention given above, and the detailed description of the embodiments given below, serve to explain the principles of the present invention.

FIG. 1 is an illustration of an embodiment of a single-eye VR adapter.

FIG. 2 is an illustration of an embodiment of a single-eye VR adapter operably coupled to a display.

FIGS. 3A and 3B are example cross-sections of a body, from view A in FIG. 1.

FIGS. 4 and 5 are illustrations of additional embodiments of a single-eye VR adapter.

FIG. 6 is an illustration of a system using two adapters with a display.

FIGS. 7 and 8 are illustration of different embodiments of two adapters coupled together.

FIG. 9 is an illustration of an embodiment of two adapters coupled together worn on a wrist.

It should be understood that the appended drawings are not necessarily to scale, presenting a somewhat simplified representation of various features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION

The following description and drawings merely illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended expressly to be only for illustrative purposes to aid the reader in understanding the principles of the invention and the concepts contributed by the inventor(s) to furthering the art and are to be construed as being without limitation to such specifically recited examples and conditions. Additionally, the term, “or,” as used herein, refers to a non-exclusive or, unless otherwise indicated (e.g., “or else” or “or in the alternative”). Also, the various embodiments described herein are not necessarily mutually exclusive, as some embodiments can be combined with one or more other embodiments to form new embodiments.

The numerous innovative teachings of the present application will be described with particular reference to the presently preferred exemplary embodiments. However, it should be understood that this class of embodiments provides only a few examples of the many advantageous uses of the innovative teachings herein. In general, statements made in the specification of the present application do not necessarily limit any of the various claimed inventions. Moreover, some statements may apply to some inventive features but not to others. Those skilled in the art and informed by the teachings herein will realize that the invention is also applicable to various other technical areas or embodiments.

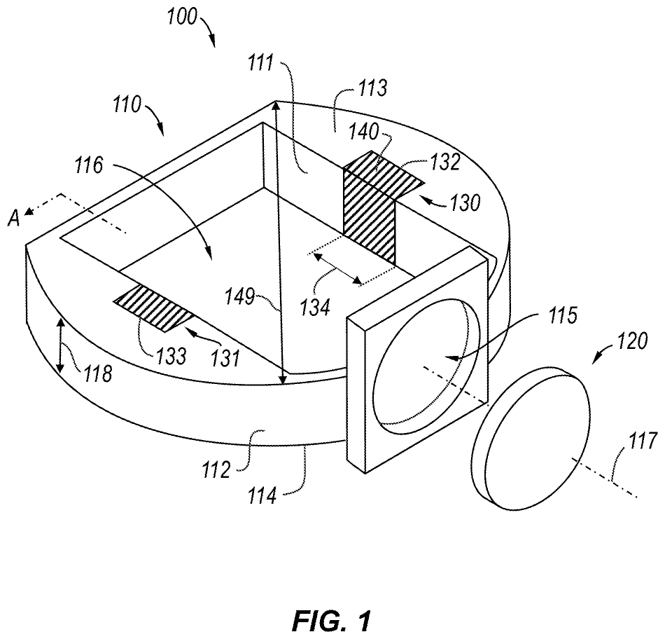

In various aspects, a single-eye virtual reality adapter may be provided. Referring to FIG. 1, a single-eye virtual reality adapter 100 may include a body 110 and a VR lens 120.

The body may have an inner surface 111 and an outer surface 112. The inner and outer surfaces may be separated by sidewalls, such as a first sidewall 113 and a second sidewall 114 opposite the first sidewall. The body may define a lens opening 115 extending from the outer surface to the inner surface. The body may define a display opening 116 extending from the first sidewall to the second sidewall.

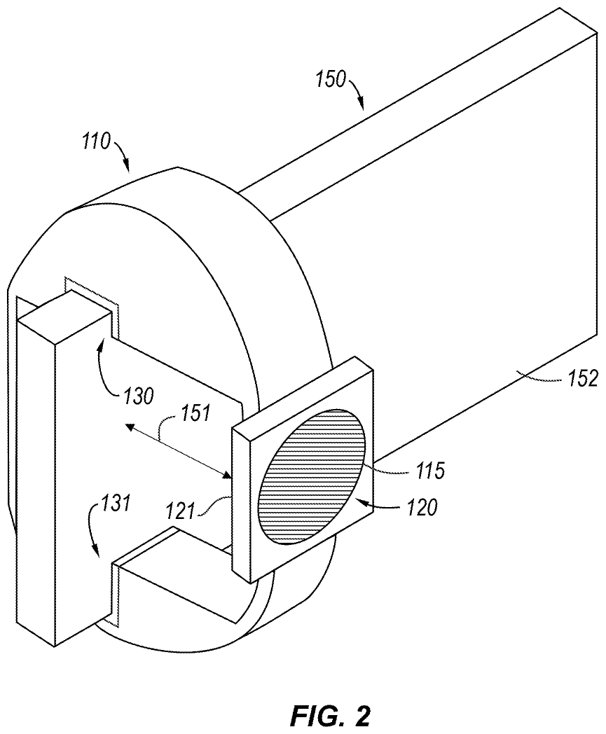

In this way, the body may be configured to be disposed around a display screen, the body configured to have a display screen slidably extended at least partially through the display opening. In FIG. 2, it can be seen that in some embodiments, a display screen 150 can be slidably received by the body 110.

The body may be comprised of any rigid or semi-rigid material. In some embodiments, the body may comprise a polymeric material (i.e., a substance composed of at least one polymer). The body may comprise a silicone material. The body may comprise a hydrocarbon resin. The body may include Acrylonitrile Butadiene Styrene (ABS), Polylactic acid (PLA), Polycarbonate (PC), Polyamide (PA), Polystyrene (PS), or a combination thereof. The body may comprise a metal. The body may comprise an elastomeric material.

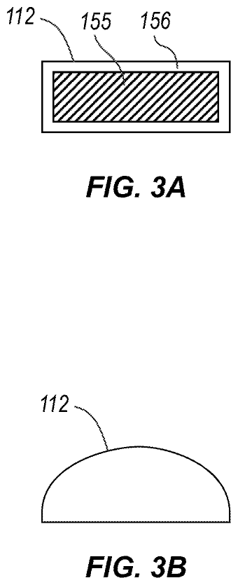

In some embodiments, the body may include a single layer. Referring to FIG. 3A, in some embodiments, the body may include a plurality of layers. For example, a body may include an inner layer 155 and an outer layer 156. In some embodiments, the inner layer may be configured to be more rigid than the outer layer. The outer layer may be configured to have a desirable texture. In some embodiments, the outer layer may include one or more elastomeric materials.

In some embodiments, the body may have a generally uniform thickness 118, the thickness being defined as a shortest distance between the first sidewall and the second sidewall at a given location. In some embodiments, a portion of the body defining the lens opening may have a first thickness that is greater than a thickness of the body at a second location.

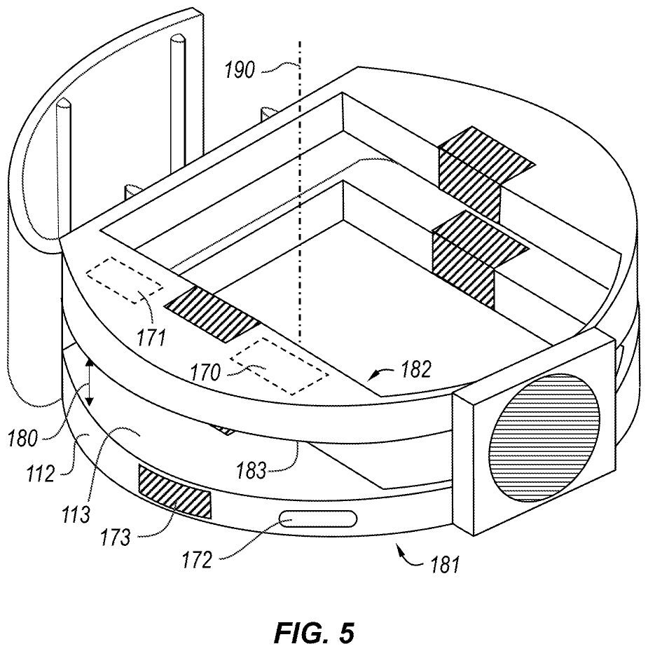

Referring briefly to FIG. 5, in some embodiments, the body may be “divided” into two portions, that may be separated in a direction parallel to a central axis 190 of the display opening. The separation may result in a gap 180 between a first sidewall 113 on a first portion 181 and an opposing sidewall 182 on a second portion 183.

The outer surface of the body may have various configurations. Referring to FIGS. 3A and 3B, in some embodiments, a portion of the outer surface may have flat (3A) or convex (3B) cross-section.

The inner surface of the body may define a set of sockets, including a first socket 130 and a second socket 131. Each socket of a set may oppose the other across the display opening. Each socket may define a recess (e.g., first recess 132, second recess 133) configured to slidably receive the display screen.

In some embodiments, a width 134 of each recess (i.e., a dimension in a direction parallel to a central axis 117 of the lens opening) may be no more than 50 mm. In some embodiments, a width of each recess may be no more than 45 mm. In some embodiments, a width of each recess may be no more than 40 mm. In some embodiments, a width of each recess may be no more than 35 mm. In some embodiments, a width of each recess may be no more than 30 mm. In some embodiments, a width of each recess may be no more than 25 mm. In some embodiments, the width of each recess may be at least 10 mm. In some embodiments, the width of each recess may be at least 7 mm. In some embodiments, the width of each recess may be at least 5 mm. In some embodiments, the width of each recess may be at least 3 mm. In some embodiments, the width of each recess may be at least 1 mm.

A compressible material may be disposed in each recess. The coefficient of friction of the compressible materials should be sufficient to prevent the display screen from sliding through the body without a user applying force. In some embodiments, each compressible material may have a coefficient of friction that is higher than a coefficient of friction of a material forming another portion of the body. The compressible material may include a foam, such as a polyurethane foam. The compressible material may include a styrenic block copolymer, such as a di- or tri-block styrenic copolymer. The compressible material may be a rubber.

The VR lens 120 may be removably coupled to the body. The VR lens may be disposed within the lens opening 115. The VR lens may be configured to be kept at a distance 151 from any display screen 150 around which the body may be disposed. In some embodiments, the VR lens may be positioned at a distance 151 (d1), where d1>0, in “front” of a portion of the display screen. That is, at least a portion of the inner surface 121 of the VR lens 120 may be configured to face an outer surface 152 of the display configured to display images to a user. Said differently, if the display include a light emitting diode (LED), the LED would emit light in the direction of the inner surface of the VR lens. In some embodiments, d1 may be equal to the effective focal length. In some embodiments, d1 may be less than the effective focal length. In some embodiments, d1 may at least the effective focal length.

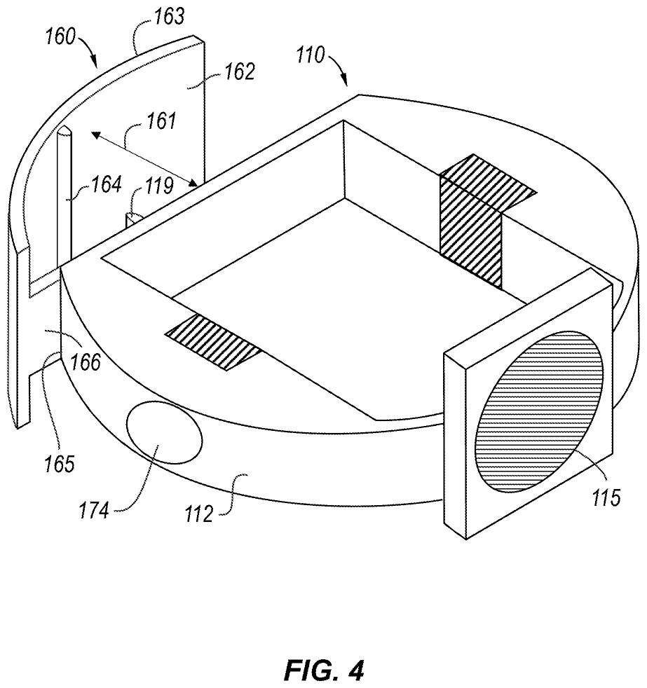

Referring to FIG. 4, the single-eye VR adapter may include a shield 160 coupled to the outer surface 112 of the body. The shield may be at a fixed position on the body, opposite the lens opening 115. The shield may be disposed at a distance 161 from the outer surface of the body. The distance (d2) may be d2>0. The shield may have an inward-facing surface 162 that faces the outer surface of the body. The shield may have an outward-facing surface 163 that faces away from the body.

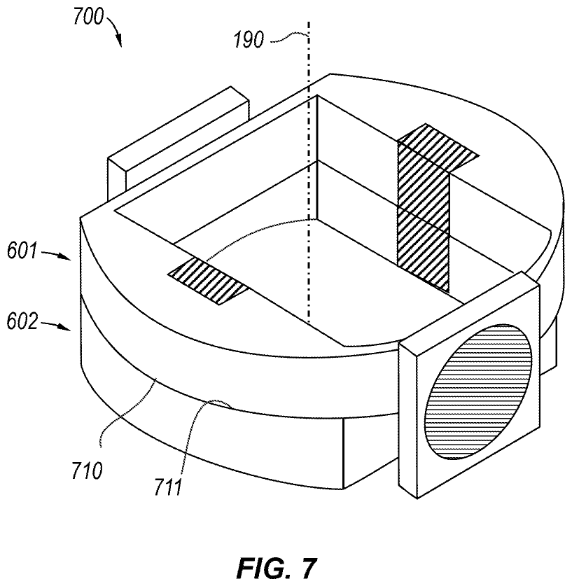

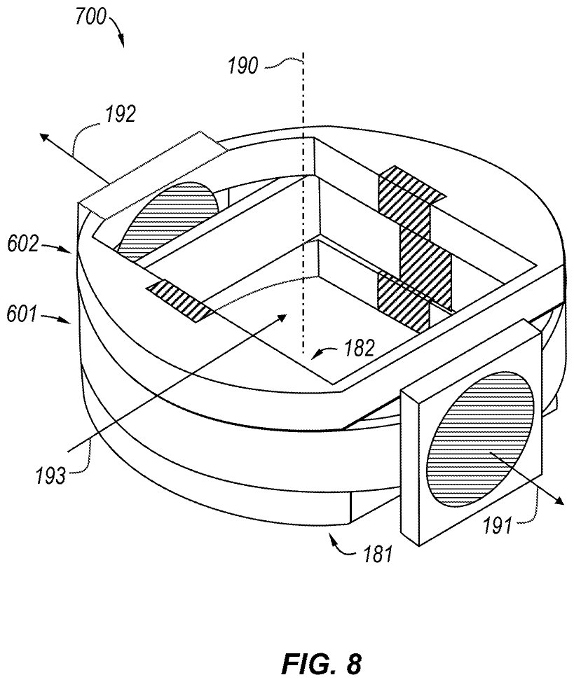

In some embodiments, the outer surface 112 of the body may include one or more protrusions 119 extending towards the inward-facing surface of the shield. In some embodiments, the inward-facing surface 162 of the shield may include one or more protrusions 164 extending towards the outer surface of the body. In some embodiments, both exist. The purpose of the shield is to protect the lens of at least one additional single-eye VR adapter when at least two single-eye VR adapters are stacked or coupled together. For example, when two or more VR adapters are coupled together as shown in FIG. 7 or 8, where the VR adapters are rotated around a central axis of the display opening from each other, a shield on a first single-eye VR adapter would protect the lens on the second single-eye adapter, and vice-versa.

In some embodiments, the shield may be coupled to the body at a single point 165. In some embodiments, the shield may be coupled directly to the body. In some embodiments, one or more extensions 166 may be present that extend from the outer surface of the body to the shield.

In some embodiments, the single-eye VR adapter may free of any electronic component. In some embodiments, the single-eye VR adapter may include one or more electronic components. Non-limiting examples of electronic components that may be used include a battery, capacitor, sensor, a speaker, a microphone, a display screen, and/or a camera. Various I/O interfaces may be incorporated as well; in some embodiments, the VR adapter may include a wireless transmitter or transceiver (such as a Wi-Fi, bluetooth, or RFID transmitter or transceiver), a USB interface, etc. Referring to FIG. 5, in one embodiments, the electronic components may include a processor 170 configured to control the various components, a battery 171, a USB I/O connection 172, and a display 173.

The single-eye VR adapter may include other components that allow it to function as a wearable device. For example, in some embodiments, the single-eye VR adapter may include a watch. See, e.g., FIG. 4, where a watch face 174 can be seen on an outer surface 112 of the body.

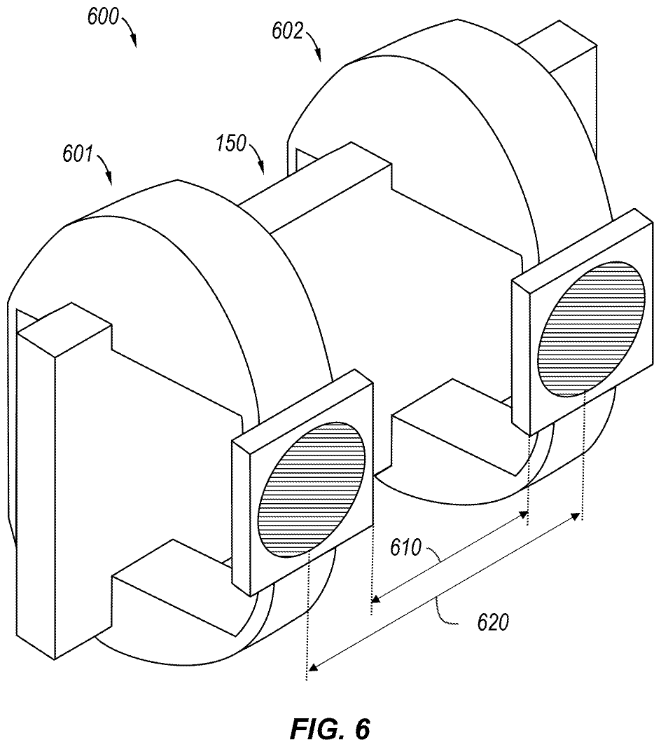

In various aspects, a system may be provided. Referring to FIG. 6, a system 600 may include a display screen 150 and a plurality of single-eye VR adapters as disclosed herein (including a first single-eye VR adapter 601 and a second single-eye VR adapter 602). The first single-eye VR adapter 601 may be separated from the second single-eye VR adapter 602 by a distance 610 (i.e., separated by a distance d3>0). This may be the minimum distance the two single-eye VR adapters are positioned in a direction parallel to the surface of the display. In some embodiments, this may be a distance configured to provide a center-to-center distance 620 between the VR lenses to match an inter-pupillary distance (IPD) for a given user.

In various aspects, a kit may be provided. The kit may include one or more VR adapter bodies, and one or more VR lenses. Each VR adapter body may be a single-eye VR adapter body as disclosed herein. Each VR adapter body may be configured to be disposed around a display screen. Each VR adapter body may have an inner surface and an outer surface, separated by a first sidewall and a second sidewall. Each VR adapter body may define a lens opening extending from the outer surface to the inner surface. Each VR adapter body may define a display opening extending from the first sidewall to the second sidewall. The VR lenses may be configured to be disposed within a lens opening of at least one of the one or more VR lenses.

The kit may include a plurality of VR adapter bodies and a plurality of VR lenses. The plurality of VR lenses includes a lens for each VR adapter body in the kit, and one or more replacement lens.

When a plurality of single-eye VR adapters are present, but not in use on the display, they may be configured to be coupled together in various ways. For example, referring to FIG. 7, in some embodiments, the devices may be configured such that, when the lenses are facing in different directions, a sidewall 710 of a first single-eye VR adapter 601 (e.g., a first sidewall 113) may be in contact with a sidewall 711 of a second single-eye VR adapter 602 (which may be a first sidewall or a second sidewall of the second single-eye VR adapter).

Referring to FIG. 8, in some embodiments, at least a portion of first single-eye VR adapter 601 in a first orientation is configured to be slidably received by the second single-eye VR adapter 602 in a second orientation, such that the lens opening of the first single-eye VR adapter faces a first direction 191, and the lens opening of the second single-eye VR adapter faces a second direction 192 different from the first direction. In some embodiments, the first single-eye VR adapter 601 is configured to be slidably received by the second single-eye VR adapter 602 when the first single-eye VR adapter is inserted between a first part 181 and a second part 182 of the second single-eye adapter. In some embodiments, the first single-eye VR adapter 601 is configured to be slidably received by the second single-eye VR adapter 602 when the first single-eye VR adapter is inserted in a direction 193 perpendicular to the central axis 190 of the display opening.

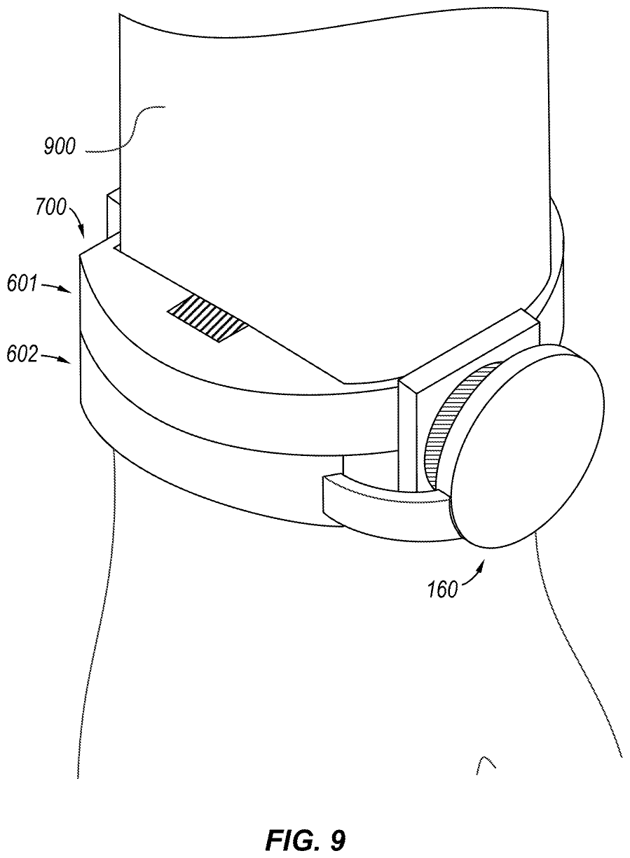

Referring to FIG. 9, in some embodiments, when the first single-eye VR adapter 601 is coupled to the second single-eye VR adapter 602, a portion of a user's body (such as the user's finger, hand, wrist, arm, foot, or leg), can extend through the display opening on the first single-eye VR adapter and the display opening of the second single-eye VR adapter (here, a portion of a user's arm 900 is shown).

In some embodiments, the body of the first and second VR adapters may be shaped identically. In some embodiments, the body of the first and second VR adapters may be shaped differently. As disclosed herein, the body of the VR adapters may include a shield. In some embodiments, each shield is identical. In some embodiments, the shield of the first single-eye VR adapter is shaped differently from the shield of the second single-eye VR adapter.

Various modifications may be made to the systems, methods, apparatus, mechanisms, techniques and portions thereof described herein with respect to the various figures, such modifications being contemplated as being within the scope of the invention. For example, while a specific order of steps or arrangement of functional elements is presented in the various embodiments described herein, various other orders/arrangements of steps or functional elements may be utilized within the context of the various embodiments. Further, while modifications to embodiments may be discussed individually, various embodiments may use multiple modifications contemporaneously or in sequence, compound modifications and the like.

Although various embodiments which incorporate the teachings of the present invention have been shown and described in detail herein, those skilled in the art can readily devise many other varied embodiments that still incorporate these teachings. Thus, while the foregoing is directed to various embodiments of the present invention, other and further embodiments of the invention may be devised without departing from the basic scope thereof. As such, the appropriate scope of the invention is to be determined according to the claims.

What is claimed is:

1. A single-eye virtual reality adapter, comprising:
a body configured to be disposed around a display screen, the body having an inner surface and an outer surface, separated by a first sidewall and a second sidewall, the body defining a lens opening extending from the outer surface to the inner surface, and defining a display opening extending from the first sidewall to the second sidewall;
a VR lens removably coupled to the body, the VR lens disposed within the lens opening, the VR lens configured to be positioned at a distance d1>0 in front of a portion of the display screen.

2. The single-eye VR adapter of claim 1, further comprising a shield coupled to the outer surface at a fixed position opposite the lens opening, the shield being disposed at a distance d2>0 from the outer surface of the body, the shield having an inward-facing surface that faces the outer surface of the body, and an outward-facing surface that faces away from the body.

3. The single-eye VR adapter of claim 2, wherein the outer surface of the body includes one or more protrusions extending towards the inward-facing surface of the shield, the inward-facing surface of the shield includes one or more protrusions extending towards the outer surface of the body, or a combination thereof.

4. The single-eye VR adapter of claim 1, wherein the inner surface defines a set of sockets, each socket opposing the other across the display opening, each socket defining a recess configured to slidably receive the display screen.

5. The single-eye VR adapter of claim 4, wherein a compressible material is disposed in each recess, each compressible material having a coefficient of friction that is higher than a coefficient of friction of a material forming another portion of the body.

6. The single-eye VR adapter of claim 5, wherein a width of the recess is no more than 25 mm, where the width is a direction parallel to a central axis of the lens opening.

7. The single-eye VR adapter of claim 1, wherein d1 is less than or equal to the effective focal length of the VR lens.

8. The single-eye VR adapter of claim 1, further comprising one or more electronic components.

9. The single-eye VR adapter of claim 8, wherein the one or more electronic components include a battery, capacitor, sensor, a speaker, a microphone, a display screen, and/or a camera.

10. The single-eye VR adapter of claim 1, further comprising a watch.

11. The single-eye VR adapter of claim 1, wherein a portion of the body defining the lens opening has a first thickness that is greater than a thickness of the body at a second location, the thickness being defined as a shortest distance between the first sidewall and the second sidewall at that location.

12. The single-eye VR adapter of claim 1, wherein at least a portion of the outer surface has flat or convex cross-section.

13. A kit comprising:
one or more VR adapter bodies, each configured to be disposed around a display screen, each VR adapter body having an inner surface and an outer surface, separated by a first sidewall and a second sidewall, each VR adapter body defining a lens opening extending from the outer surface to the inner surface, and defining a display opening extending from the first sidewall to the second sidewall; and
one or more VR lenses, each configured to be disposed within the lens opening.

14. The kit of claim 13, wherein the kit comprises a plurality of VR adapter bodies and a plurality of VR lenses.

15. The kit of claim 14, wherein the plurality of VR lenses includes a lens for each VR adapter body in the kit, and one or more replacement lens.

16. The kit of claim 14, wherein at least a portion of first single-eye VR adapter in a first orientation is configured to be slidably received by the second single-eye VR adapter such that the lens opening of the first single-eye VR adapter faces a first direction, and the lens opening of the second single-eye VR adapter faces a second direction different from the first direction.

17. The kit of claim 16, wherein when the first single-eye VR adapter is coupled to the second single-eye VR adapter, a user's hand, wrist, or arm can extend through the display opening on the first single-eye VR adapter and the display opening of the second single-eye VR adapter.

18. The kit of claim 13, wherein the body of the first single-eye VR adapter is shaped differently from the body of the second single-eye VR adapter.

19. The kit of claim 18, wherein the shield of the first single-eye VR adapter is shaped differently from the shield of the second single-eye VR adapter.

20. A system comprising:
a display screen;
a plurality of single-eye virtual reality (VR) adapters, including a first single-eye VR adapter and a second single-eye VR adapter, each single-eye VR adapter comprising:
a body disposed around a portion of the display screen, the body defining an lens opening extending from an outer surface of the body to an inner surface of the body;
a VR lens disposed within the lens opening, the VR lens configured to be positioned at a distance d1>0 mm in front of a portion of the display screen;
wherein the first single-eye VR adapter is separated from the second single-eye VR adapter.
